(19) United States
(12) Patent Application Publication
(10) Pub. No.: US 2010/0318817 A1
(43) Pub. Date: Dec. 16, 2010

(54) Information Processing Apparatus and System State Control Method

(76) Inventor: Takehiko Nanbu, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/758,666

(22) Filed: Apr. 12, 2010

(30) Foreign Application Priority Data
Jun. 15, 2009 (JP) 2009-142420

(51) Int. Cl. G06F 1/26

(52) U.S. Cl. 713/300

(57) ABSTRACT

According to an aspect of the present invention, there is provided an information processing apparatus operable in an ordinary mode, a standby mode and a hibernation mode, the apparatus including: a sensor that measures a working-environment parameter of the apparatus; a backup circuit that is connected to the sensor and that supplies an electric power to the sensor when the apparatus is in the standby mode; a controller that includes an allowable range storage portion storing an allowable range for the working-environment parameter and that controls a supply of an electric power to the backup circuit; and a first unit that changes the apparatus from the standby mode to the hibernation mode based on the measured working-environment parameter and the stored allowable range.

### CROSS-REFERENCE TO RELATED APPLICATIONS

This application is based upon and claims the benefit of priority from Japanese Patent Application No. 2009-142420, filed on Jun. 15, 2009, the entire contents of which are incorporated herein by reference.

### BACKGROUND

1. Field

An aspect of the present invention relates to an information processing apparatus and particularly to system state control in the information processing apparatus.

2. Description of the Related Art

Various personal computers (PCs) which can be battery-driven have been developed in recent years. Power management technology for reducing power consumption has been used in this type PCs. ACPI (Advanced Configuration and Power Interface) Specification has been known as the power management technology.

The ACPI Specification defines system states S0 to S5. The system state S0 is an ordinary mode (a state where the PC is powered on and in execution of software). The system state S5 is shutdown (a state where the PC is powered off and not in execution of any software). The system states S1 to S4 are sleep modes (states where the context of software just before mode change to one of the sleep modes is stored in a storage device and the software programs are stopped) between the ordinary mode and the shutdown mode.

The system state S3 is also called standby mode. In the system state S3, a main memory is supplied with power to hold the contents of the main memory but all devices except the main memory are powered off when the PC is stopped. When a wakeup event occurs (e.g. when a power button is pushed down) in the standby mode (S3), the system state is restored from the standby mode (S3) to the ordinary mode (S0) so that execution of software can be resumed speedily at the state just before a power-off event occurred.

The system state S4 is also called hibernation mode. In the system state S4, the PC is powered off after data on the main memory are copied to a secondary storage device such as a hard disk drive (HDD) when the PC is stopped. When a wakeup event occurs (e.g. when a power button is pushed down) in the hibernation mode (S4), the system state is restored from the hibernation mode (S4) to the ordinary mode (S0) so that execution of software can be resumed at the state just before a power-off event occurred.

Generally, the power consumptions in these system states are S0>S1>S2>S3>S4>S5.

JP-H05-204779-A discloses a technique in which a controller controls a backup power supply to supply electric power to a volatile memory, a memory holding device and a memory access device immediately at the time of detection of abnormality in electric power so that a data transfer device transfers data from the volatile memory to a nonvolatile memory in accordance with a command issued from the controller.

However, in the technique disclosed in JP-H05-204779-A, data held in the memory will be damaged when abnormality occurs in a working environment (e.g. when abnormality occurs in a working temperature, a working humidity or a working altitude) of a PC during the standby mode (S3).

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an information processing apparatus according to an embodiment.

FIG. 2 illustrates a system configuration of the information processing apparatus shown in FIG. 1.

FIG. 3 illustrates the schematic configuration of a nonvolatile memory in an EC/KBC shown in FIG. 2.

FIG. 4 illustrates a transition of system states which can be taken by the information processing apparatus shown in FIG. 1.

FIG. 5 illustrates an exemplary operation of a system state control method in the embodiment.

FIG. 6 illustrates an exemplary error message scene displayed on a display monitor during system state transition from a standby mode to a hibernation mode, of the information processing apparatus according to the embodiment.

### DETAILED DESCRIPTION

Various embodiments according to the present invention will be described hereinafter with reference to the accompanying drawings. In general, according to one embodiment of the present invention, there is provided an information processing apparatus operable in an ordinary mode, a standby mode and a hibernation mode, the apparatus including: a sensor that measures a working-environment parameter of the apparatus; a backup circuit that is connected to the sensor and that supplies an electric power to the sensor when the apparatus is in the standby mode; a controller that includes an allowable range storage portion storing an allowable range for the working-environment parameter and that controls a supply of an electric power to the backup circuit; and a first unit that changes the apparatus from the standby mode to the hibernation mode based on the measured working-environment parameter and the stored allowable range.

An embodiment of the invention will be described below with reference to the drawings.

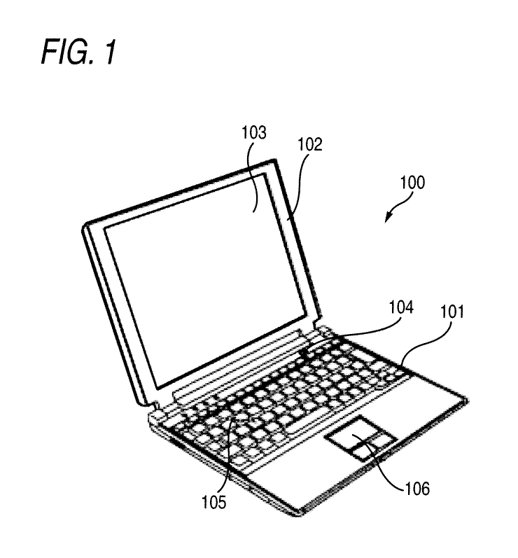

First, a configuration of an information processing apparatus according to the embodiment will be described with reference to FIGS. 1 to 3. The information processing apparatus is implemented, for example, as a battery-driven notebook-type personal computer 100 (hereinafter abbreviated to computer 100).

FIG. 1 is a perspective view of the computer 100 in a state where a display unit is opened. The computer 100 includes a body unit 101, and the display unit 102.

The display unit 102 has a built-in display device made of an LCD (Liquid Crystal Display) 103. A display portion of the LCD 103 is disposed substantially in the center of the display unit 102.

The display unit 102 is supported and attached to the body unit 101 so that the display unit 102 can rotate relative to the body unit 101 between an open position where an upper surface of the body unit 101 is revealed and a close position where the upper surface of the body unit 101 is covered with the display unit 102.

The body unit 101 has a housing shaped like a thin box. A power button 104 for powering on/off the computer 100, a keyboard 105 and a touch pad 106 are disposed in the upper surface of the body unit 101.

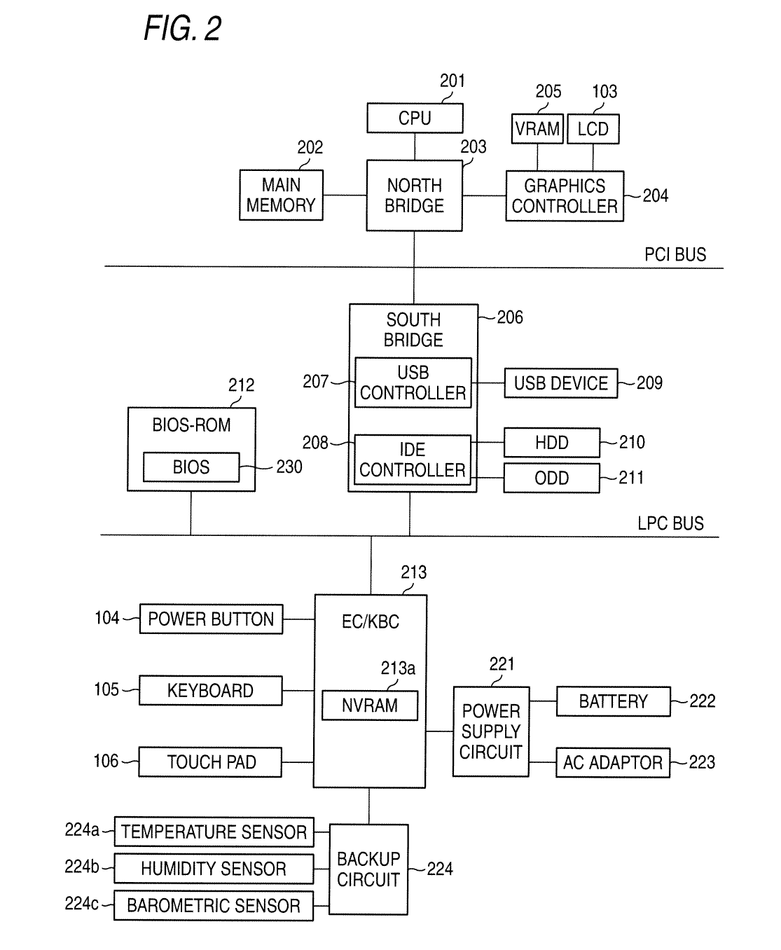

FIG. 2 is a block diagram showing a system configuration of the computer 100.

As shown in FIG. 2, the computer 100 has a CPU 201, a main memory 202, a north bridge 203, a graphics controller 204, the LCD 103, a VRAM 205, a south bridge 206, a USB controller 207, an IDE controller 208, a USB device 209, a hard disk drive (HDD) 210, an optical disk drive (ODD) 211, a BIOS-ROM 212, the power button 104, the keyboard 105, the touch pad 106, an embedded controller/keyboard controller (EC/KBC) 213, a power supply circuit 221, a battery 222, an AC adaptor 223, a backup circuit 224, a temperature sensor 224a, a humidity sensor 224b and a barometric sensor 224c.

The CPU 201 is a processor for totally controlling the operation of the computer 100. The CPU 201 executes an OS and various application programs loaded to the main memory 202. The OS and the various application programs are stored in a magnetic disk storage medium (hard disk) etc. in the HDD 210 and loaded from the storage medium to the main memory 202.

The CPU 201 also executes a BIOS program 230 (hereinafter referred to as BIOS) stored in the BIOS-ROM 212. The BIOS-ROM 212 is configured of a nonvolatile memory such as a flash EEPROM to make the program rewritable.

The BIOS 230 is a program for controlling various hardware components of the computer 100. When the computer 100 is started up, the BIOS 230 is read from the BIOS-ROM 212.

The north bridge 203 is a bridge device which connects a local bus of the CPU 201 and the south bridge 206 to each other. The north bridge 203 has a memory controller for access control of the main memory 202. The north bridge 203 communicates with the graphics controller 204 through an AGP (Accelerated Graphics Port) bus, etc.

The graphics controller 204 controls the LCD 103 used as a display monitor of the computer 100. This graphics controller 204 outputs a video signal corresponding to display data written in the VRAM 205 by the OS or one of the application programs, to the LCD 103.

The south bridge 206 controls respective devices on an LPC (Low Pin Count) bus and a PCI (Peripheral Component Interconnect) bus. The south bridge 206 has, as built-in controllers, the USB controller 207 for controlling the USB device 209 and the IDE controller 208 for controlling the HDD 210 and the ODD 211.

The HDD 210 is a storage device which has a hard disk controller, and a magnetic disk storage medium. Various kinds of software programs including the OS and various kinds of data are stored in the magnetic disk storage medium. The ODD 211 drives a storage medium such as a DVD storing video contents such as a DVD title, a CD storing music data, etc.

The EC/KBC 213 is a one-chip microcomputer into which an embedded controller (EC) for power management and a keyboard controller (KBC) for controlling the keyboard 105 and the touch pad 106 are integrated. The EC/KBC 213 is always supplied with electric power from the power supply circuit 221 regardless of whether the computer 100 is powered on or off. The EC/KBC 213 cooperates with the power supply circuit 221 to power on/off the computer 100 in response to a use's operation of the power button 104.

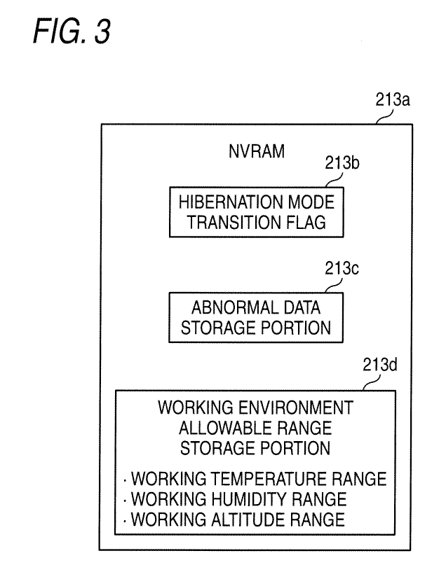

The EC/KBC 213 has a nonvolatile memory (NVRAM) 213a. As shown in FIG. 3, the NVRAM 213a includes a hibernation mode transition flag 213b which indicates that the computer 100 changes from the standby mode (S3) to the hibernation mode (S4) because of abnormality in working environment. The NVRAM 213a further includes an abnormal data storage portion 213c which stores abnormal data when the computer 100 changes from the standby mode (S3) to the hibernation mode (S4) because of abnormality in working environment. The NVRAM 213a further includes a working environment allowable range storage portion 213d which stores allowable ranges of parameters (temperature, humidity and altitude in this embodiment) for an environment where the computer 100 can work.

The power supply circuit 221 supplies electric power to respective devices of the computer 100 by using internal electric power from the battery 222 provided in the body unit 101 or external electric power supplied from an external power supply through the AC adaptor 223 under control of the EC/KBC 213.

The backup circuit 224 is controlled by the EC/KBC 213 to be supplied with electric power through the battery 222 or the AC adaptor 223 even when the computer 100 is in the standby mode (S3). The temperature sensor 224a, the humidity sensor 224b and the barometric sensor 224c for measuring the temperature, the humidity and the altitude in the working environment of the computer 100, respectively, are connected to the backup circuit 224. The backup circuit 224 supplies electric power to the group of sensors connected to the backup circuit 224.

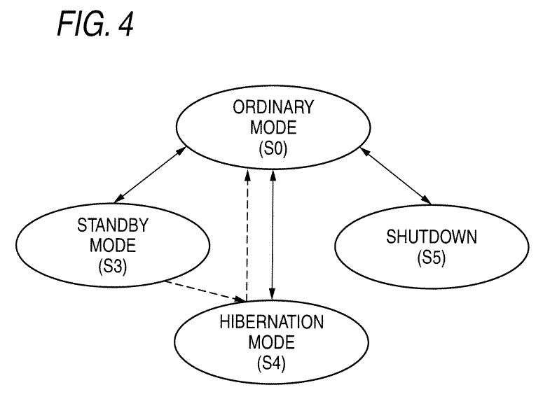

Next, transition of system states which can be taken by the computer 100 will be described with reference to FIG. 4.

The computer 100 according to the embodiment can be changed between the ordinary mode (S0) and the shutdown (S5), between the ordinary mode (S0) and the standby mode (S3) and between the ordinary mode (S0) and the hibernation mode (S4) as represented by the solid lines in FIG. 4.

In addition, after the standby mode (S3) is selected, the computer 100 according to the embodiment can be restored from the standby mode (S3) to the ordinary mode (S0) via the hibernation mode (S4) as represented by the broken lines in FIG. 4. The system state transition is performed when a parameter for the working environment of the computer 100, such as the temperature measured by the temperature sensor 224a, becomes out of an allowable range.

For example, these pieces of system state information are stored in a register (not shown) provided in the south bridge 206 (FIG. 2).

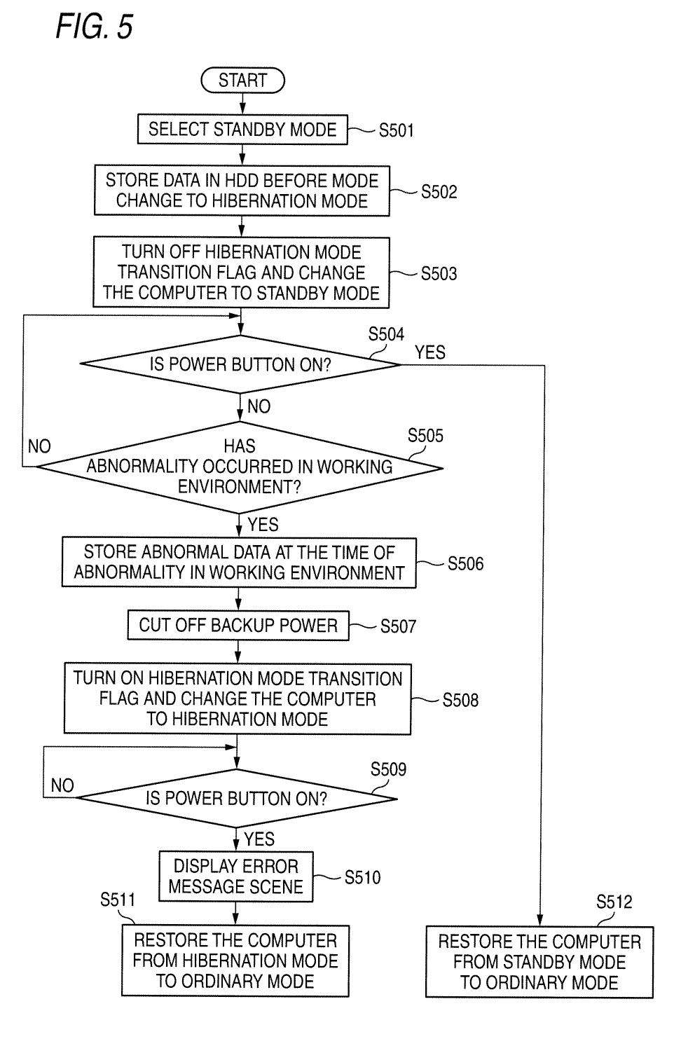

FIG. 5 is a flow chart showing an exemplary operation of a system state control method in the embodiment for restoring the computer 100 from the standby mode (S3) to the ordinary mode (S0) via the hibernation mode (S4). In the embodiment, temperature, humidity and altitude are assumed as parameters for a working environment of the computer 100. Allowable ranges of these parameters are assumed as follows.
Working Temperature: 5° C. to 35° C.
Working Humidity: 20% to 80% (relative humidity)
Working Altitude: −60 m to 3000 m

It is assumed that the computer 100 starts from the ordinary mode (S0) in this operation.

First in step S501, the standby mode (S3) is selected in the computer 100. For example, this step S501 is performed by a user's button operation or by a user's operation of closing the display unit 102 with respect to the body unit 101.

Then, the OS (CPU 201) controls so that all data of the main memory 202 are stored in the HDD 210, as when the computer 100 is changed from the ordinary mode (S0) to the hibernation mode (S4) (step S502).

Then, the BIOS 230 (CPU 201) turns off the hibernation mode transition flag 213a of the NVRAM 213a and changes the computer 100 to the standby mode (S3) (step S503). Incidentally, electric power is supplied to the main memory 202, the EC/KBC 213 and the backup circuit 224 during the standby mode (S3).

During the standby mode (S3), the EC/KBC 213 detects whether the power button 104 is pushed down or not (step S504). When the EC/KBC 213 detects the pushing-down of the power button 104 (YES in the step S504), the BIOS 230 is started up and the BIOS 230 (CPU 201) reads the off state of the hibernation mode transition flag 213b of the NVRAM 213a and restores the computer 100 from the standby mode (S3) to the ordinary mode (S0) (step S512).

On the other hand, when the power button 104 is not pushed down during the standby mode (S3) (NO in the step S504), the EC/KBC 213 compares values measured by the temperature sensor 224a, the humidity sensor 224b and the barometric sensor 224c with values stored in the working environment allowable range storage portion 213d of the NVRAM 213a to determine whether abnormality occurs in the working environment of the computer 100 or not (step S505).

Accordingly, the EC/KBC 213 continues detection (step S504) as to whether the power button 104 is pushed down and detection (step S505) as to whether abnormality occurs in the working environment while the values measured by the temperature sensor 224a, etc. are in the allowable ranges stored in the working environment allowable range storage portion 213d, that is, while there is no abnormality in the working environment of the computer 100 (NO in the step S505).

On the other hand, when the values measured by the temperature sensor 224a, etc. are out of the allowable ranges stored in the working environment allowable range storage portion 213d, that is, when abnormality occurs in the working environment of the computer 100 (YES in the step S505) as represented by 0° C. indicated by the value measured by the temperature sensor 224a, this operation goes to step S506.

In the step S506, the BIOS 230 is started up and the BIOS 230 (CPU 201) stores abnormal data at the time of occurrence of abnormality in the working environment of the computer 100 (the temperature of 0° in this case) in the abnormal data storage portion 213c of the NVRAM 213a. Then, the EC/KBC 213 cuts off electric power supplied to the backup circuit 224 (step S507) and the BIOS 230 (CPU 201) turns on the hibernation mode transition flag 213b of the NVRAM 213a and changes the computer 100 from the standby mode (S3) to the hibernation mode (S4) (step S508).

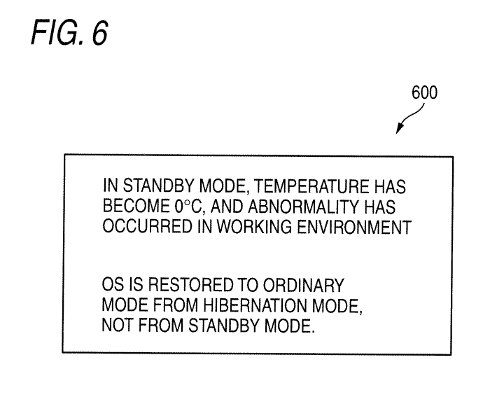

During the hibernation mode (S4), the EC/KBC 213 detects whether the power button 104 is pushed down or not (step S509). The EC/KBC 213 continues processing of the step S509 while the power button 104 is not pushed down (NO in the step S509). On the other hand, when the EC/KBC 213 detects the pushing-down of the power button 104 (YES in the step S509), the BIOS 230 is started up and the BIOS 230 (CPU 201) reads the on state of the hibernation mode transition flag 213b of the NVRAM 213a and displays an error message scene as represented by a display scene 600 shown in FIG. 6 (step S510). Then, the BIOS 230 (CPU 201) restores the computer 100 from the hibernation mode (S4) to the ordinary mode (S0) (step S511).

According to the embodiment, protection of data and prevention of failure can be attained because the computer 100 can be changed rapidly from the standby mode (S3) to the hibernation mode (S4) when abnormality occurs in the working environment of the computer 100 during the standby mode (S3). As a result, user-friendliness of the computer 100 can be improved.

According to the embodiment, maintenance engineers, etc. in charge of maintenance of the computer 100 can analyze abnormal date to use the data effectively for the future development, etc. because the abnormal data can be stored when abnormality occurs in the working environment of the computer 100 during the standby mode (S3).

Although a preferred embodiment of the invention has been described above, the invention is not limited only to the embodiment per se. Constituent members of the embodiment can be modified and put into practice without departing from the gist of the invention.

In the embodiment, when the computer 100 is changed to the standby mode (S3), data on the main memory 202 are also stored in the HDD 210 so that the computer 100 can be changed from the standby mode (S3) to the hibernation mode (S4). However, data on the main memory 202 may be stored in an SSD (Solid State Drive) connected to an eSATA controller provided in the computer 100. In this case, data on the main memory just before the hibernation mode (S4) can be reproduced rapidly when the computer 100 is restored from the hibernation mode (S4) to the ordinary mode (S0).

In the embodiment, abnormal data is stored (only once) when the computer 100 is changed from the standby mode (S3) to the hibernation mode (S4) because of abnormality in the working environment of the computer 100. However, accumulated abnormal data may be stored whenever abnormality occurs.

In the embodiment, temperature, humidity and altitude (atmosphere pressure) are used as parameters for a working environment of the computer 100. However, the other parameter may be used instead of or in addition to the above parameters. For example, a vibration sensor may be mounted on the computer 100. In this case, when the computer 100 is used in a transportation vehicle such as an automobile and a train, an excessive vibration can be detected as an abnormality in a working environment. For example, a battery sensor to measure a remaining power of the battery 222 may be provided, and the measured remaining power may be used as the parameter.

According to an aspect of the present invention, there are provided an information processing apparatus and a system state control method in which data can be protected and the possibility of failure can be reduced when abnormality occurs in an environment of the information processing apparatus used in a standby mode.

What is claimed is:

1. An information processing apparatus operable in an ordinary mode, a standby mode and a hibernation mode, the apparatus comprising:
a sensor that measures a working-environment parameter of the apparatus;
a backup circuit that is connected to the sensor and that supplies an electric power to the sensor when the apparatus is in the standby mode;
a controller that includes an allowable range storage portion storing an allowable range for the working-environment parameter and that controls a supply of an electric power to the backup circuit; and
a first unit that changes the apparatus from the standby mode to the hibernation mode based on the measured working-environment parameter and the stored allowable range.

2. The apparatus of claim 1,
wherein the apparatus is changed from the standby mode to the hibernation mode when the working-environment parameter measured by the sensor becomes out of the allowable range stored in the allowable range storage portion.

3. The apparatus of claim 2,
wherein the controller stops the supply of the electric power to the backup circuit after the working-environment parameter measured by the sensor becomes out of the allowable range stored in the allowable range storage portion.

4. The apparatus of claim 1, further comprising:
a display monitor; and
a second unit that restores the apparatus from the hibernation mode to the ordinary mode;
wherein the controller includes a flag storage portion that stores a flag indicating whether the apparatus had been changed from the standby mode to the hibernation mode, and
wherein the display monitor selectively displays a message indicating that the apparatus had been restored from the standby mode to the ordinary mode via the hibernation mode based on the flag when the apparatus is restored from the hibernation mode to the ordinary mode.

5. The apparatus of claim 1,
wherein the controller includes a memory portion, and
wherein the controller stores the working-environment parameter measured by the sensor into the memory portion when the apparatus is changed from the standby mode to the hibernation mode.

6. The apparatus of claim 1,
wherein the working-environment parameter includes at least one of a temperature, a humidity and an altitude.

7. A system state control method for an information processing apparatus operable in an ordinary mode, a standby mode and a hibernation mode,
wherein the apparatus comprises:
a sensor that measures a working-environment parameter of the apparatus;
a backup circuit that is connected to the sensor and that supplies an electric power to the sensor when the apparatus is in the standby mode; and
a controller that includes an allowable range storage portion storing an allowable range for the working-environment parameter and that controls a supply of an electric power to the backup circuit, and
wherein the method comprises:
changing the apparatus from the standby mode to the hibernation mode based on the measured working-environment parameter and the stored allowable range.

8. The method of claim 7,
wherein the apparatus is changed from the standby mode to the hibernation mode when the working-environmental parameter measured by the sensor becomes out of the allowable range stored in the allowable range storage portion.

9. The method of claim 8, further comprising:
stopping the supply of the electric power to the backup circuit after the working-environment parameter measured by the sensor becomes out of the allowable range stored in the allowable range storage portion.

10. The method of claim 7, further comprising:
activating a flag when the apparatus had been changed from the hibernation mode to the ordinary mode;
restoring the apparatus from the hibernation mode to the ordinary mode; and
selectively displaying, on a display monitor of the apparatus, a message indicating that the apparatus had been restored from the standby mode to the ordinary mode via the hibernation mode based on the flag when the apparatus is restored from the hibernation mode to the ordinary mode.

11. The method of claim 7, further comprising:
storing the working-environment parameter measured by the sensor into a memory portion of the controller when the information processing apparatus is changed from the standby mode to the hibernation mode.

12. The method of claim 7,
wherein the working-environment parameter includes at least one of a temperature, a humidity and an altitude.
